(19) United States
(12) Patent Application Publication
(10) Pub. No.: US 2024/0347242 A1
(43) Pub. Date: Oct. 17, 2024

(54) SOFT MAGNETIC ALLOY PARTICLE AND INDUCTOR INCLUDING THE SAME

(71) Applicant: SAMSUNG ELECTRO-MECHANICS CO., LTD., Suwon-si (KR)

(72) Inventors: Seongjae Lee, Suwon-si (KR); Jongho Chung, Suwon-si (KR); Jihoon Hwang, Suwon-si (KR); Jihye Kim, Suwon-si (KR); Byung Soo Kang, Suwon-si (KR); Chin Mo Kim, Suwon-si (KR)

(73) Assignee: SAMSUNG ELECTRO-MECHANICS CO., LTD., Suwon-si (KR)

(21) Appl. No.: 18/588,880

(22) Filed: Feb. 27, 2024

(30) Foreign Application Priority Data
Apr. 14, 2023 (KR) 10-2023-0049600

(51) Int. Cl. H01F 1/153; H01F 27/245

(52) U.S. Cl. CPC H01F 1/15308; H01F 1/15316; H01F 1/15333; H01F 27/245

(57) ABSTRACT

Soft magnetic alloy particles according to the present disclosure include nanocrystals and amorphous phase and Fe (iron) and Ge (germanium). An average content of Ge in the amorphous phase is Ge(a) (at %) and an average content of Ge in the nanocrystal is Ge(c) (at %), and Ge(a)−Ge(c)>0.

### CROSS-REFERENCE TO RELATED APPLICATION

This application claims priority to and the benefit of Korean Patent Application No. 10-2023-0049600 filed in the Korean Intellectual Property Office on Apr. 14, 2023, the entire contents of which are incorporated herein by reference.

### TECHNICAL FIELD

The present disclosure relates to a soft magnetic particle and an inductor including the same.

### BACKGROUND

In recent times, as electronic devices have been down-sized and more highly integrated, a power supply voltage has been lowered, and accordingly, a current value has been increased to transmit the same power. Accordingly, a metal inductor maintaining inductor performance even at a high current has been applied, but recently, in order to secure the use at a further higher current, a material having high current characteristics, that is, a material having a high magnetic saturation (Ms) value has been applied.

In conventional Fe-based soft magnetic materials, the electromagnetic properties are improved by adjusting the content of elements such as Si to bring the magnetostriction close to zero. However, when the content of Si is increased, a content of metals such as Fe is reduced, making it difficult to improve the Ms value.

In addition, when the content of metals such as Fe is excessively high, the Ms value may be increased, but there is another problem that the nanocrystals locally grow during the heat treatment. Accordingly, this problem results in growth of non-uniform crystals, deteriorating the electromagnetic properties of the soft magnetic material.

### SUMMARY

One aspect of embodiments provides a soft magnetic alloy particle capable of maintaining high magnetic saturation characteristics and improving electromagnetic properties.

Another aspect of embodiments provides an inductor using the soft magnetic alloy particle.

However, problems to be solved by the embodiments are not limited to the above-described problems and may be variously expanded within the range of technical ideas included in the embodiments.

Soft magnetic alloy particles according to an embodiment include nanocrystals and amorphous phase, and include Fe (iron) and Ge (germanium), and an average content of Ge in the amorphous phase is Ge(a) (at %) and an average content of Ge in the nanocrystal is Ge(c) (at %), and Ge(a)−Ge(c)>0.

A composition of the soft magnetic alloy particles may be represented by Composition Formula 1.

FeₐCo_{b}Ge_{c}M_{d} Composition Formula 1

In Composition Formula 1, a, b, c, and d represent an atomic percentage content (at %) of corresponding elements, respectively, 0<a≥90, 0≤b≤10, 0<c≤5, 0<d≤20, a+b+c+d=100, and M includes B, P, Cu, Nb, Cr, C, Ni, Al, Mn, Ag, Zn, Sn, As, Sb, Bi, N, O, S, or a combination thereof.

The M may not include Si.

In the above, c may satisfy 0.5≤c≤4.

In the above, a may satisfy 70≤a≤80.

In the above, b may satisfy 2≤b≤6.

In the above, a and b may satisfy 75≤a+b≤90.

In the above, d may satisfy 10≤d≤20.

In the above, Ge(a) and Ge(c) may satisfy 0.1≤Ge(a)−Ge(c)≤0.7.

M may include B, P, Cu, or a combination thereof.

Crystallinity of the soft magnetic alloy particle may be greater than or equal to about 59% and less than or equal to about 70%.

An average crystal size of the nanocrystals may be less than or equal to about 20 nm.

An inductor according to another embodiment includes a body including a magnetic material including soft magnetic alloy particles; a coil in the body; and an external electrode on an outer surface of the body. The soft magnetic alloy particles may include nanocrystals and amorphous phase, and include Fe (iron) and Ge (germanium), and an average content of Ge in the amorphous phase is Ge(a) (at %) and an average content of Ge in the nanocrystal is Ge(c) (at %), and Ge(a)−Ge(c)>0.

A composition of the soft magnetic alloy particles may be represented by Composition Formula 1.

FeₐCo_{b}Ge_{c}M_{d} Composition Formula 1

In Composition Formula 1, a, b, c, and d represent an atomic percentage content (at %) of corresponding elements, respectively, 0<a≥90, 0≤b≤10, 0<c≤5, 0<c≤20, a+b+c+d=100, and M includes B, P, Cu, Nb, Cr, C, Ni, Al, Mn, Ag, Zn, Sn, As, Sb, Bi, N, O, S, or a combination thereof.

The M may not include Si.

In the above, c may satisfy 0.5≤c≤4.

Crystallinity of the soft magnetic alloy particles may be greater than or equal to about 59% and less than or equal to about 70%.

An average crystal size of the nanocrystals may be less than or equal to about 20 nm.

In the inductor according to an embodiment, the coil may include a support member and an upper coil and a lower coil respectively on upper and lower surfaces of the support member, and the upper coil and the lower coil may be connected through a via penetrating the support member.

In the inductor according to another embodiment, the body may include a mold portion, a cover portion on one surface of the mold portion, and a core protruding from one surface of the mold portion. The coil may be between one surface of the mold portion and the cover portion, and the core may penetrate through the coil.

In the inductor according to another embodiment, the body may include a plurality of magnetic sheets including the magnetic material.

According to the soft magnetic alloy particles according to the embodiment, high magnetic saturation characteristics can be maintained while improving electromagnetic properties.

However, the various advantageous advantages and effects of the present invention are not limited to the above descriptions, and will be more easily understood in the process of describing specific embodiments of the present invention.

### BRIEF DESCRIPTION OF THE DRAWINGS

FIG. 1 is a photograph of soft magnetic alloy particles observed with a transmission electron microscope (TEM) according to an embodiment.

FIG. 2 is a photograph of conventional soft magnetic alloy particles observed with a transmission electron microscope (TEM).

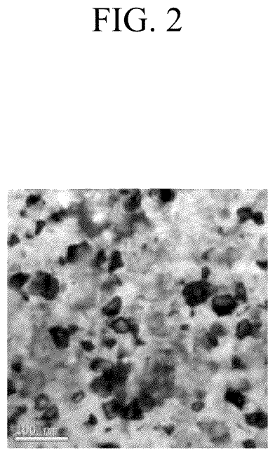

FIG. 3 shows a line profile (bottom) by spot quantitative analysis through TEM analysis (top) of soft magnetic alloy particles according to an embodiment.

FIG. 4 shows a line profile (bottom) by spot quantitative analysis through TEM analysis (top) of soft magnetic alloy particles according to an embodiment.

FIG. 5 is a perspective view of an inductor according to an embodiment.

FIG. 6 is a cross-sectional view schematically illustrating an incision surface in the direction I-I′ of FIG. 5.

FIG. 7 is an enlarged view of region A of FIG. 6.

FIG. 8 is a perspective view of an inductor according to another embodiment.

FIG. 9 is a cross-sectional view schematically illustrating an incision surface in the direction II-II′ of FIG. 8.

FIG. 10 is a perspective view of an inductor according to another embodiment.

FIG. 11 is a cross-sectional view schematically illustrating an incision surface in the direction III-III′ of FIG. 10.

### DETAILED DESCRIPTION OF THE EMBODIMENTS

Hereinafter, various embodiments of the present invention will be described in detail with reference to the accompanying drawings so that those skilled in the art may easily carry out the present invention. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present invention includes all modifications, equivalents, and substitutions without departing from the scope and spirit of the present invention. In addition, some constituent elements in the accompanying drawings are exaggerated, omitted, or schematically illustrated, and the size of each constituent element does not entirely reflect the actual size.

In addition, unless explicitly described to the contrary, the word “comprise”, and variations such as “comprises” or “comprising”, will be understood to imply the inclusion of stated elements but not the exclusion of any other elements.

Through the specification, the “stacking direction” refers to a direction in which constituent elements are sequentially stacked or the “thickness direction” perpendicular to the large surface (main surface) of the sheet-shaped constituent elements, which corresponds to a T-axis direction in the drawing.

In addition, the “side direction” refers to a direction extending parallel to the large surface (main surface) from the edge of the sheet-shaped constituent elements or a “planar direction”, which corresponds to an L-axis direction in the drawing.

Further, the W-axis direction in the drawing may be a “width direction”.

Hereinafter, various embodiments and modifications will be described in detail with reference to the drawings.

### Soft Magnetic Alloy Particle

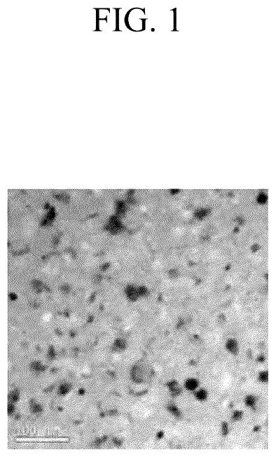

FIG. 1 is a photograph of soft magnetic alloy particles observed with a transmission electron microscope (TEM) according to an embodiment. For reference, a boundary between the amorphous phase portion and the nanocrystal portion may be defined by dividing a portion having a contrast difference by a method such as binarizing a transmission electron microscope (TEM) image.

Referring to FIG. 1, the soft magnetic alloy particles according to an embodiment include nanocrystals and amorphous phase, and include Fe (iron) and Ge (germanium).

The soft magnetic alloy particles according to an embodiment may be represented by Composition Formula 1.

FeₐCo_{b}Ge_{c}M_{d} [Composition Formula 1]

In Composition Formula 1, a, b, c, and d represent an atomic percentage content (at %) of corresponding elements, respectively, 0<a≤90, 0≤b≤10, 0<c≤5, 0<d≤20, and a+b+c+d=100.

M may include B, P, Cu, Nb, Cr, C, Ni, Al, Mn, Ag, Zn, Sn, As, Sb, Bi, N, O, S, or a combination thereof.

In an embodiment, M may include B, P, Cu, or a combination thereof.

In an embodiment, M may not include Si.

In Composition Formula 1, a represents an atomic percentage content of Fe (iron) metal, and may satisfy 70≤a≤80.

In Composition Formula 1, b represents an atomic percentage content of Co (cobalt) metal, and may satisfy 2≤b≤6.

In Composition Formula 1, 75≤a+b≤90. If a+b is less than 75, the saturation magnetization value is low, and high current characteristics may be poor, and if a+b exceeds 90, it is difficult to control the size of nanocrystals, and thus electromagnetic properties may be poor.

In Composition Formula 1, 10≤d≤20.

c represents the atomic percentage content of the Ge (germanium) element, and may satisfy 0.5≤c≤4. If c is less than 0.5, it is difficult to control the size of the nanocrystal, which may lead to poor electromagnetic properties. If c exceeds 4, the content of Fe and Co, which are metals, is relatively low, making it difficult to secure high current characteristics.

As a specific example, Composition Formula 1 may be Fe_{79.4}Co₄Ge_{0.5}B₁₀P_{5.5}Cu_{0.6}, Fe_{79.4}Co₄Ge₁B₁₀P₅Cu_{0.6}, Fe_{79.4}Co₄Ge₂B₁₀P₄Cu_{0.6}, Fe_{78.4}Co₄Ge₃B₁₀P₄Cu_{0.6}, or Fe_{77.4}Co₄Ge₄B₁₀P₄Cu_{0.6}.

In the soft magnetic alloy particles according to an embodiment, when the average content of Ge in the amorphous phase is Ge(a) (at %) and the average content of Ge in the nanocrystal is Ge(c) (at %), Ge(a)−Ge(c)>0.

The Ge(a) means an average content (at %) of Ge element based on all atoms constituting the amorphous phase portion of the soft magnetic alloy particle. In addition, the Ge(c) means an average content (at %) of Ge element based on all atoms constituting the nanocrystal portion of the soft magnetic alloy particle.

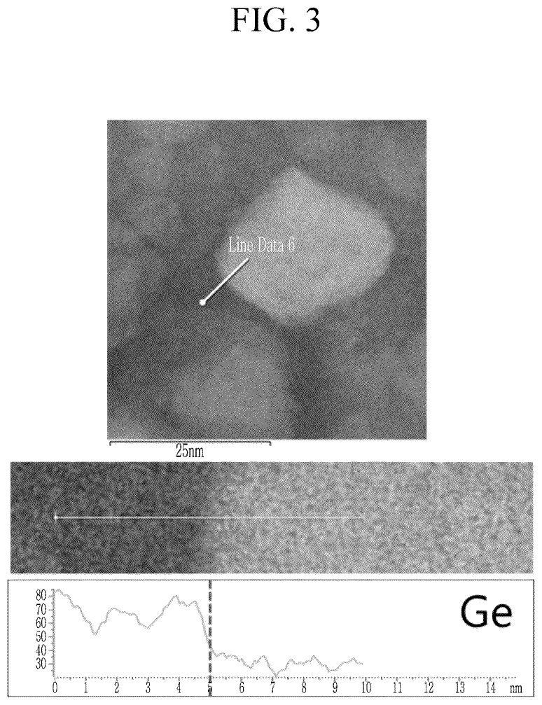

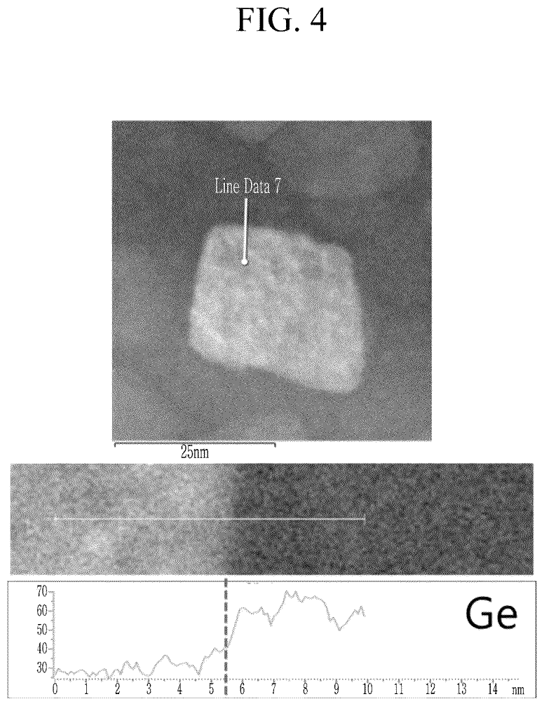

FIGS. 3 and 4 show a line profile (bottom) by spot quantitative analysis through TEM analysis (top) of a soft magnetic alloy particle according to an embodiment. For reference, a boundary between the amorphous phase portion and the nanocrystal portion may be defined by dividing a portion having a contrast difference by a method such as binarizing a transmission electron microscope (TEM) image. In FIGS. 3 and 4, relatively bright portions correspond to nanocrystals and relatively dark portions correspond to amorphous phase.

Referring to FIGS. 3 and 4, the Ge(a) and Ge(c) are measured through line analysis using an EDS (Energy Disperse X-Ray Spectrometer) installed in a transmission electron microscope (TEM).

Specifically, based on the surface of any one nanocrystal particle, in the line profile of spot quantitative analysis by 20 nm to the inside and 200 nm to the outside of the nanocrystal particle, the maximum value inside the nanocrystal particle and the maximum value in the amorphous phase portion are compared.

In addition, in order to measure the average, the analysis described above is repeated at least 5 points and the average value is calculated.

Referring to FIGS. 3 and 4, in the case of soft magnetic alloy particles containing Ge, which does not contain Si and has a relatively larger atomic weight than Si, according to an embodiment, the Ge element is more present in amorphous phase than nanocrystals.

In an embodiment, 0.1 (at %)≤Ge(a)−Ge(c)≤0.7 (at %). If the Ge(a)−Ge(c) value is less than 0.1 (at %), it may become difficult to control the size of Ge nanocrystals, resulting in poor electromagnetic properties, and if the Ge(a)−Ge(c) value is 0.7 (at %) is exceeded, high current characteristics may become low.

In an embodiment, a difference between the first crystallization temperature (Tₓ₁) and the second crystallization temperature (Tₓ₂) of the soft magnetic alloy particles may exceed about 100° C. If the difference between the first crystallization temperature (Tₓ₁) and the second crystallization temperature (Tₓ₂) is less than about 100° C., as a result of the narrowing of the difference between Tₓ₁ and Tₓ₂, it becomes difficult to obtain a homogeneous nanocrystal structure, resulting in deterioration of soft magnetic properties.

The amorphous phase constituting the soft magnetic alloy particles has at least two exothermic peaks indicating crystallization during the heating process of the DSC curve obtained by differential scanning calorimetry (DSC).

Among the exothermic peaks, the exothermic peak at the lowest temperature indicates the first crystallization in which the a-Fe primary phase crystallizes, and the subsequent exothermic peak indicates the second crystallization in which the secondary phase of the Fe—B compound crystallizes.

Herein, the first crystallization start temperature Tₓ₁ is defined as a temperature at the intersection of a first rising tangent line and the baseline wherein the first rising tangent line is a tangent line passing through a point having the largest positive slope among the first rising portions from the baseline of the DSC curve to reaching the first peak, which is the exothermic peak at the lowest temperature side.

In addition, the second crystallization start temperature Tₓ₂ is defined as a temperature of the intersection of a second rising tangent line and a baseline wherein the second rising tangent line is a tangent line passing through the point with the largest positive slope among the second rising portions from the baseline to the second peak, which is the exothermic peak next to the first peak.

In an embodiment, the soft magnetic alloy particles may have a crystallinity of greater than or equal to about 40% or greater than or equal to about 59% and less than or equal to about 75% or less than or equal to about 70% as calculated by Equation 1. Since the crystal fraction of the soft magnetic alloy particles is improved to a level of about 60%, advantageous results can be obtained in terms of high Ms.

$$Crystallinity ( \% ) = [ Ic / ( Ic + Ia ) ] \times 100 \qquad [ Equation 1 ]$$

In Equation 1, Ic is a sum of scattering intensity integrals of crystalline peaks in the X-ray diffraction analysis spectrum of the soft magnetic alloy particle, and Ia is a sum of integral values of scattering intensities of amorphous halo in the X-ray diffraction analysis spectrum of the soft magnetic alloy particle.

The crystallinity of the soft magnetic alloy particle may be calculated based on a graph obtained by X-ray diffraction spectroscopy. In the X-ray diffraction analysis spectrum, a relationship of 2d·sin θ=nλ is established between a wavelength λ and incident angle θ of the incident X-ray and a lattice spacing d, which is called the Bragg equation. Accordingly, when the incident angle is determined, the lattice spacing d can be obtained.

However, since a random arrangement rather than a regular atomic arrangement appears in an amorphous material, a plurality of X-ray diffraction does not appear at a specific wavelength, and a broad halo pattern appears in a region with a diffraction angle of 15° to 35°. If there is no peak appearing at a specific angle within the diffraction angle range of 10° to 60° and a diffuse halo pattern appears, it can be determined that the amorphous material has crystallinity of 0%. However, the surface of the soft magnetic alloy particle exposed to X-rays must not contain contaminants other than organic material. Reliability is high as long as the result is measured under the condition that there are no factors affecting the diffraction pattern.

If crystals exist in the soft magnetic alloy particle, one or more crystalline peaks exist in the measured diffraction angle range. The presence of a peak means that the peak can be recognized with the naked eye at least on the X-ray diffraction diagram with the maximum intensity in the range of the diffraction angle of 2θ=5° or more and 50° or less in the XRD pattern graph as the entirety of the vertical axis, or that the waveform processing unit can clearly distinguish it from background noise and recognize it as a peak.

At this time, if the crystallinity is high, the halo region is reduced, and the halo region does not exist in a material with crystallinity of 100%. When crystal and amorphous are mixed, the crystallinity can be calculated by calculating the relative ratio of the area of the crystalline peak and the area of the halo region in the graph including intensity and diffraction angle range.

The nanocrystals of the soft magnetic alloy particles may be amorphous grains.

In an embodiment, an average crystal size of the nanocrystals of the soft magnetic alloy particles may be less than or equal to about 20 nm, for example, less than or equal to about 18 nm.

For example, the average crystal size of the nanocrystals can be calculated using the Scherer equation using the full width at half maximum (FWHM) of the main peak of the XRD graph.

Alternatively, the average size of the nanocrystals may be obtained by measuring the largest long axis of at least 100 nanocrystals in a scanning electron microscope (SEM) image of a cross-section of a soft magnetic alloy particle to prepare a size distribution curve, and calculating D50 as the average size.

The above-described soft magnetic alloy particles do not include Si element but include Ge element having a relatively larger atomic weight than Si element, and during heat treatment, Ge element may be more amorphous phase than nanocrystal. Accordingly, the Ge element can improve electromagnetic properties such as magnetic permeability and core loss by controlling the size of the nanocrystal to a certain size or less by acting as an inhibitor to prevent the growth of the nanocrystal.

In addition, by increasing the second crystallization temperature, the heat treatment process window for forming nanocrystals is improved, so that homogeneous nanocrystals can be obtained and the crystal fraction can be improved to a high level. Accordingly, a high saturation magnetization (Ms) characteristic can be maintained.

### Inductor

Hereinafter, an example of the inductor 100 including a magnetic material including the soft magnetic alloy particles described above will be described. Types of the inductor may include a thin film-type inductor, a multilayer-type inductor, a wound-type inductor, or a rolled-type inductor, and the thin film-type inductor will be described first.

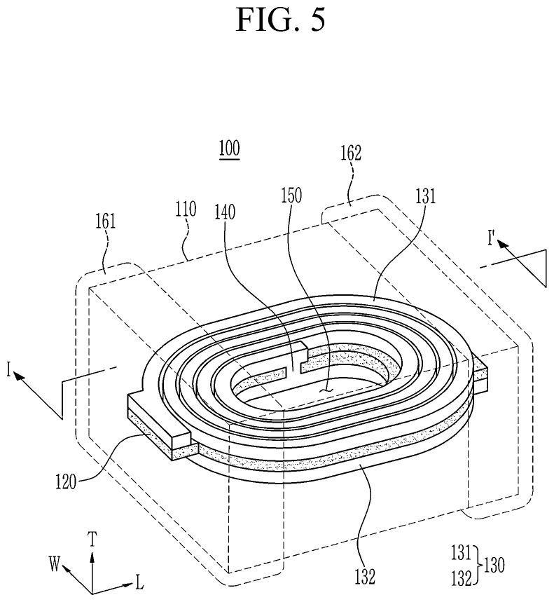

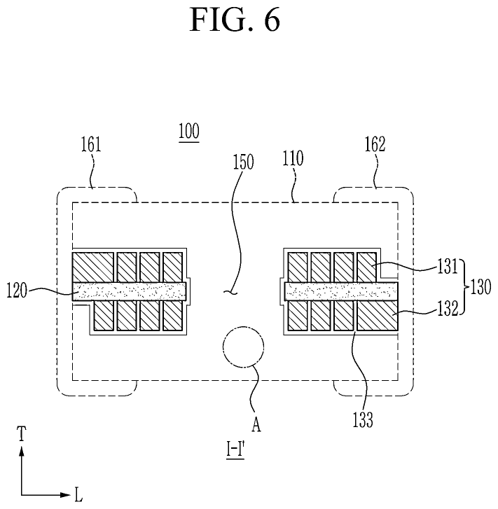

FIG. 5 is a schematic perspective view of a thin film-type inductor according to an embodiment, and FIG. 6 is a schematic view of an incision surface in an I-I′ direction of FIG. 5, schematically showing a cross-sectional view of the inductor shown in FIG. 5. The thin film-type inductor 100 according to an embodiment includes a body 110 including a magnetic material including a soft magnetic alloy particle, a coil 130 in the body, and external electrodes 161 and 162 on the outer surface of the body 110.

The body 110 forms the appearance of the thin film-type inductor 100.

The body 110 may have a hexahedral shape including upper and lower surfaces facing each other in a stacking direction of coils, side surfaces facing in a side direction and front and rear faces facing each other in a width direction, and when the printed circuit board is mounted, the lower surface (other surface) of the body may be a mounting surface. A corner where each surface meets may be rounded by grinding or the like.

The body 110 may be formed by forming the coil 130, stacking sheets including magnetic materials on top and bottom of the coil 130, and then compressing and curing the sheet.

The body 110 includes a magnetic material, and the magnetic material includes soft magnetic alloy particles according to an embodiment.

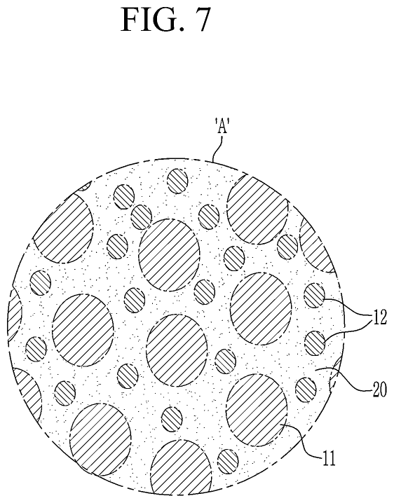

FIG. 7 is an enlarged view of region A of FIG. 6.

Referring to FIGS. 6 and 7, the magnetic material may include a resin 20 and magnetic particles including coarse powder magnetic particles 11 or fine powder magnetic particles 12. For example, the coarse powder magnetic particles 11 and the fine powder magnetic particles 12 may be mixed and dispersed in a predetermined ratio using the resin 20 as a matrix.

The coarse powder magnetic particles 11 may be particles having an average particle diameter of about 10 μm to about 30 μm, and the fine powder magnetic particles 12 may be particles having an average particle diameter of about 1 μm to about 10 μm.

A diameter of the magnetic particles present in the body 110 may be measured from a cross section of the body 110. Specifically, with respect to the cross section in the L-T direction passing through the center of the body 110, a plurality of regions (e.g., 10 regions) at equal intervals in the T-axis direction are photographed with a scanning electron microscope, and then the diameter of the magnetic particle can be obtained using an image analysis program. In this case, since the outer region of the body 110 may be deformed or destroyed by a compression process or the like, the diameter of the magnetic particle may be measured except for this region. For example, a region corresponding to a length within about 5% or about 10% of the surface of the body 110 may be excluded.

As the magnetic particles, those used in the industry may be used without limitation. For example, ferrite or a metal-based soft magnetic material may be used as the magnetic particles.

The ferrite may include known ferrites such as Mn—Zn-based ferrite, Ni—Zn-based ferrite, Ni—Zn—Cu-based ferrite, Mn—Mg-based ferrite, Ba-based ferrite, or Li-based ferrite.

The metal-based soft magnetic material may be an alloy containing at least one selected from Fe, Si, Cr, Al, and Ni, and may include, for example, Fe—Si—B—Cr-based amorphous metal particles, but is not limited thereto.

In an embodiment, the magnetic particles include soft magnetic alloy particles, and for example, the coarse powder magnetic particles may be the soft magnetic alloy particles.

The resin may be an insulating resin, and may include an epoxy resin, a polyimide resin, a liquid crystal polymer, or a combination thereof, but is not limited thereto.

The soft magnetic alloy particle includes nanocrystals and amorphous phase, and includes Fe (iron) and Ge (germanium).

The soft magnetic alloy particle may be represented by Composition Formula 1.

FeₐCo_{b}Ge_{c}M_{d} [Composition Formula 1]

In Composition Formula 1, a, b, c, and d represent an atomic percentage content (at %) of corresponding elements, respectively, 0<a≥90, 0≤b≤10, 0<c≤5, 0<c≤20, a+b+c+d=100, and

M includes B, P, Cu, Nb, Cr, C, Ni, Al, Mn, Ag, Zn, Sn, As, Sb, Bi, N, O, S, or a combination thereof.

M may include B, P, Cu, or a combination thereof and M may not include Si.

c represents an atomic percentage content of Ge (germanium) element, and may be 0.5≤c≤4. If c is less than 0.5, it is difficult to control the size of the nanocrystal, which may lead to poor electromagnetic properties. If c exceeds 4, the content of Fe and Co, which are metals, is relatively low, making it difficult to secure high current characteristics.

In the soft magnetic alloy particles, when an average content of Ge in the amorphous phase is Ge(a) (at %) and an average content of Ge in the nanocrystal is Ge(c) (at %), Ge(a)−Ge(c)>0.

The Ge(a) means an average content (at %) of Ge element based on all atoms constituting the amorphous phase portion of the soft magnetic alloy particle. In addition, the Ge(c) means an average content (at %) of Ge element based on all atoms constituting the nanocrystal portion of the soft magnetic alloy particle.

A method of measuring Ge(a) and Ge(c) in the inductor 100 is as follows.

In a cross-sectional sample cut in the L-axis direction and the T-axis direction from the center of the W-axis direction of the inductor body 110 (hereinafter referred to as “cross-sectional sample”), the soft magnetic alloy particle dispersed in the resin is subjected to line analysis using an Energy Disperse X-Ray Spectrometer (EDS) installed in a Transmission Electron Microscope (TEM).

The cross-sectional sample of the inductor body 110 may be, for example, prepared by adding the inductor 100 in an epoxy mixture and curing, and then polishing the L-axis and T-axis sides of the inductor body 110 to the ½ point in the W-axis direction, and fixing and holding in a vacuum atmosphere chamber.

Specifically, based on the surface of any one nanocrystal particle included in the soft magnetic alloy particle, in the line profile of spot quantitative analysis by 20 nm to the inside and 200 nm to the outside of the nanocrystal particle, the maximum value inside the nanocrystal particle and the maximum value in the amorphous phase portion are compared. In addition, in order to measure the average, the analysis described above is repeated at least 5 points and the average value is calculated.

The soft magnetic alloy particles may have a crystallinity of greater than or equal to about 40% or greater than or equal to about 59% and less than or equal to about 75% or less than or equal to about 70% as calculated by Equation 1.

$$Crystallinity ( \% ) = [ Ic / ( Ic + Ia ) ] \times 100 \qquad [ Equation 1 ]$$

In Equation 1, Ic is a sum of scattering intensity integrals of crystalline peaks in the X-ray diffraction analysis spectrum of the soft magnetic alloy particle, and Ia is a sum of integral values of scattering intensities of amorphous halo in the X-ray diffraction analysis spectrum of the soft magnetic alloy particle.

Specifically, the crystallinity of the soft magnetic alloy particles may be calculated through Equation 1 after obtaining an XRD graph of the soft magnetic alloy particles in the cross-sectional sample of the inductor body 110. An XRD graph of the soft magnetic alloy particles can be obtained through a sample obtained by pulverizing and sieving a cross-sectional sample of the body to a size of greater than or equal to about 20 μm. The meaning of the term “about” or the like may include a process error occurring in the manufacturing process, a measurement error, or the like, recognizable by one of ordinary skill in the art. For example, being “about X” in which “X” is a number may mean being exactly “X” or may include a tolerable deviation from “X” due to a process error occurring in the manufacturing process, a measurement error, or the like, recognizable by one of ordinary skill in the art.

An average crystal size of the nanocrystals included in the soft magnetic alloy particle may be less than or equal to about 20 nm, for example less than or equal to about 18 nm.

For example, the average crystal size of the nanocrystals can be calculated using the Scherer equation using the full width at half maximum (FWHM) of the main peak of the XRD graph.

Specifically, the average crystal size of the nanocrystals may be calculated by using the full width at half maximum after obtaining an XRD graph of the soft magnetic alloy particles in the cross-sectional sample of the inductor body 110. An XRD graph of the soft magnetic alloy particles can be obtained through a sample obtained by pulverizing and sieving a cross-sectional sample of the body to a size of greater than or equal to about 20 μm.

For example, the average crystal size of the nanocrystals can also be measured in a scanning electron microscope (SEM) or transmission electron microscope (TEM) image of a cross-sectional sample of the body, in a soft magnetic alloy particle corresponding to coarse powder magnetic particles having a particle diameter of about 10 μm to about 30 μm. Specifically, in the image of the cross-sectional sample, with the central point in the L-axis direction as the reference, it can be derived by measuring the size of nanocrystals generated inside the coarse powder magnetic particles observed in a plurality of regions (e.g., 10 regions) at predetermined intervals in the T-axis direction, and calculating the average value. Intervals between the plurality of regions may be adjusted according to the scale of a scanning electron microscope (SEM) or transmission electron microscope (TEM) image, and may be equally spaced. At this time, all of the plural regions must be located within the body, and if all 10 points are not located within the body, the position of the reference point may be changed or the interval between the 10 points may be adjusted.

Since the soft magnetic alloy particles is the same as that described above, the rest of the description is omitted.

In an embodiment, an insulating film (not shown) may be additionally disposed on the surface of the soft magnetic alloy particles to impart insulating properties and secure inductance.

The insulating film may be disposed in one or more layers, and may be disposed in a maximum of three layers. For example, the insulating film may be an organic film including an epoxy resin, a polyimide resin, a liquid crystal polymer, or a combination thereof, and may include silicon oxide (SiO) or silica (SiO₂), an inorganic film including alumina (Al₂O₃), or a metal oxide film such as FeO (iron oxide) or CrO (chromium oxide). When the insulating film is the metal oxide film, the metal oxide film may include a metal element included in the soft magnetic alloy particles, but is not limited thereto.

A thickness of the insulating film may be about 1% to about 20% of a particle diameter of the soft magnetic alloy particle.

If the thickness of the insulating film exceeds about 20% of the particle diameter of the soft magnetic alloy particle, magnetic permeability and magnetic susceptibility may be reduced, and thus it is desirable to make the thickness as thin as possible.

The coil 130 is disposed inside the body 110 and plays a role of expressing characteristics of the inductor. For example, when the inductor 100 is used as a power inductor, the coil stores an electric field as a magnetic field to maintain an output voltage, thereby stabilizing a power supply of an electronic device. The coil may be any type among a wound-type formed in a winding method, a thin film-type formed in a thin film method, or a multilayer-type formed in a stacking method, but hereinafter, the thin film-type coil may be described as an example.

The coil 130 may include an upper coil 131 and a lower coil 132 respectively disposed on the upper and lower surfaces of a support member 120. The upper coil 131 and the lower coil 132 may be coil layers disposed facing each other with respect to the support member 120.

The upper coil 131 and the lower coil 132 may be formed as plating layers on the support member 120 in a plating process or a photolithography method.

The coil 130 may be made of a material with excellent electrical conductivity, for example, at least one type of metal selected from gold (Au), silver (Ag), platinum (Pt), copper (Cu), nickel (Ni), palladium (Pd), aluminum (Al), titanium (Ti), and the like or an alloy thereof, but any conventional conductive material may be adopted without particular limitations.

The support member 120 may be made of any material capable of supporting the upper coil 131 and the lower coil 132 without particular limitations, for example, a copper clad laminate (CCL), a polypropylene glycol (PPG) substrate, a ferrite substrate, a metal-based soft magnetic substrate, or the like. In addition, an insulation substrate made of an insulation resin may be used. The insulation resin may include a thermosetting resin such as an epoxy resin, a thermoplastic resin such as polyimide, or a resin in which a reinforcing material such as a glass fiber or an inorganic filler is impregnated, such as prepreg, ABF (ajinomoto build-up film), FR-4, a BT (bismaleimide triazine) resin, a PID (photo imagable dielectric) resin, etc. In terms of maintaining rigidity, an insulation substrate including the glass fiber and the epoxy resin may be used but is not limited thereto.

The upper and lower surfaces of the support member 120 may be penetrated to form a hole, and the hole may be filled with a magnetic material to form a core portion 150. The core portion filled with the magnetic material may improve inductance.

The upper coil 131 and the lower coil 132 stacked on both surfaces of the support member are electrically connected through a via 140 penetrating the support member 120.

The via 140 may be formed by using a mechanical drill or a laser drill to form a through-hole and filling the through-hole with a conductive material through plating.

The via 140 may not be particularly in terms of a shape or a material, as long as the upper coil 131 and the lower coil 132 respectively disposed on both upper and lower surfaces of the support member 120 are electrically connected. Herein, the upper and lower surfaces are determined, based on a stacking direction of coil patterns in the drawing.

The via 140 may include a conductive material such as copper (Cu), aluminum (Al), silver (Ag), tin (Sn), gold (Au), nickel (Ni), lead (Pd), or an alloy thereof, and the like.

The upper and lower coils 131 and 132 may be covered with an insulating layer 133 not to directly connect the magnetic material included in the body 110.

The insulating layer 133 may serve to protect the upper and lower coils 131 and 132.

The insulating layer 133 may be formed of any material including an insulating material, for example, an insulating material used for a conventional insulation coating, for example, an epoxy resin, a polyimide resin, a liquid crystal crystalline polymer resin, and the like, wherein a known photo imageable dielectric (PID) resin may be used, but is not limited thereto.

The insulating layer 133 may be formed in a vapor deposition method and the like but not limited thereto and formed to be laminated on both surfaces of the support member.

The inductor 100 according to an embodiment is electrically connected to the upper and lower coils 131 and 132 and includes the external electrodes 161 and 162 on the outer surface of the body 110.

The external electrodes 161 and 162 are electrically connected to each draw-out terminal of the upper and lower coils 131 and 132 exposed on both sides of the body 110.

The external electrodes 161 and 162, when the inductor 100 is mounted on an electronic device, serve to electrically connect the coil 130 inside the inductor to the electronic device.

The external electrodes 161 and 162 may be formed using a conductive paste including a conductive metal, and the conductive metal may be at least one of copper (Cu), nickel (Ni), tin (Sn), and silver (Ag) or an alloy thereof.

The external electrodes 161 and 162 may include a plating layer formed on the paste layer.

The plating layer may include at least one selected from nickel (Ni), copper (Cu), and tin (Sn), and for example, a nickel (Ni) layer and a tin (Sn) layer may be sequentially formed.

Hereinafter, the wound-type inductor 200 and multilayer-type inductor 300 will be described in detail. Hereinafter, the wound-type inductor 200 and the multilayer-type inductor 300 will be described only with respect to configuration differences from that of the thin film-type inductor 100. The descriptions of the thin film-type inductor 100 may be applied to the rest of the configuration thereof.

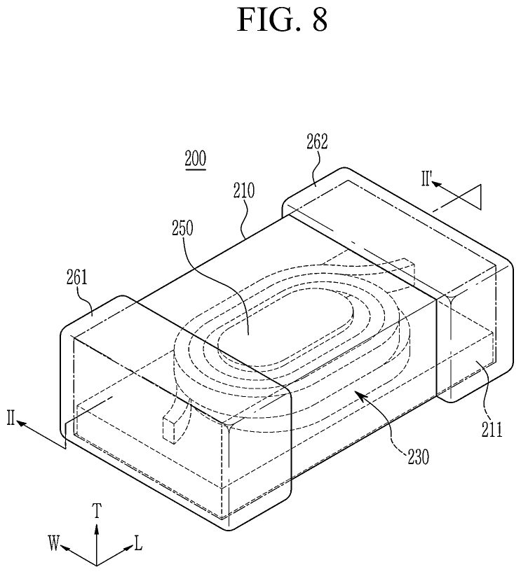

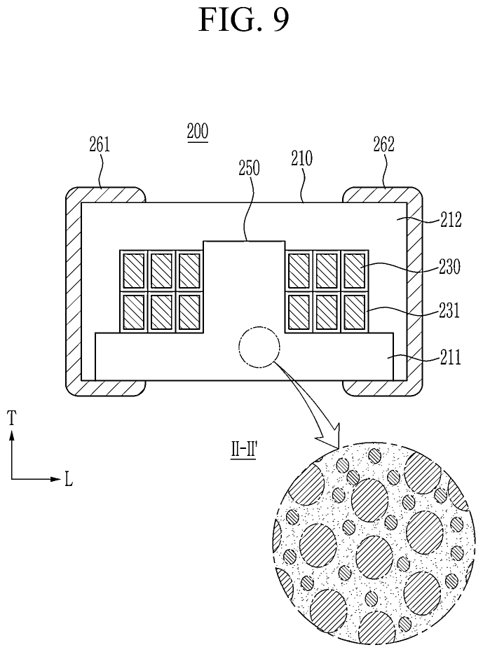

FIG. 8 schematically shows a transmission perspective view of the wound-type inductor according to another embodiment, and FIG. 9 schematically shows a cross-section of the inductor of FIG. 8 cut in a II-II′ direction of FIG. 8.

The wound-type inductor 200 according to an embodiment includes a body 210 including a magnetic material including soft magnetic alloy particles, a coil 230 inside the body, and external electrodes 261 and 262 on the outer surface of the body 210.

In an embodiment, the body 210 includes a mold portion 211, a cover portion 212 disposed on one surface of the mold portion 211, and a core 250 protruded from one surface of the mold portion 212. The coil 230 is disposed between one surface of the mold portion 211 and the cover portion 212, and the core 250 penetrates the coil 230.

The body 210 of the wound-type inductor 200 includes the mold portion 211 and the cover portion 212 disposed on one surface of the mold portion 211 and further include the core 250 disposed to be protruded from one surface of the mold portion 211. Herein, the coil 230 may be disposed one surface of the mold portion 211 to wrap the core 250.

The body 210 includes a magnetic material, and the magnetic material includes soft magnetic alloy particles according to an embodiment. In other words, at least one of the mold portion 211, the cover portion 212, and the core 250 includes the magnetic material including the soft magnetic alloy particles. For example, the mold portion 211 may be formed by filling the magnetic material in a mold. As another example, the mold portion 211 may be formed by filling a composite material including the magnetic material and a resin in the mold. A process of applying a high temperature and a high pressure to the magnetic material or the composite material in the mold may be additionally performed but is not limited thereto. The mold portion 211 and the core 250 may be integrally formed by the aforementioned mold without a boundary therebetween. The cover portion 212 may be formed by disposing a magnetic composite sheet in which the magnetic material is dispersed in the resin on the mold portion 211 and the coil 230 and then, heating and pressing it.

In the wound-type inductor 200, a draw-out portion (not shown) penetrates the mold portion 211 to be connected to the external electrodes 261 and 262.

The descriptions of the thin film-type inductor 100 according to an embodiment may be equally applied to the magnetic material and the soft magnetic alloy particles in the body 210.

In the wound-type inductor 200, the surface of the coil 230 may be covered with an insulating layer 231, and the insulating layer 231 serves to insulate the magnetic material of the body 210 from the coil 230. The same descriptions of the insulating layer 133 may be applied to those of the insulating layer 231.

The wound-type inductor 200 is different from the thin film-type inductor 100, in terms of the configuration of the coil 230 and the presence or absence of the support member.

The coil 230 is a wound-type and includes no support member. The coil 230 may be a wound coil formed by winding a metal wire such as a copper wire (Cu-wire) including a metal line and the insulating layer 231 covering the surface of the metal line and the like. The metal wire may be a flat line but is not limited thereto.

In FIG. 8, the coil 230 is shown as an alpha (α)-shaped wound wire but only exemplary and may be an edge-wise wound wire.

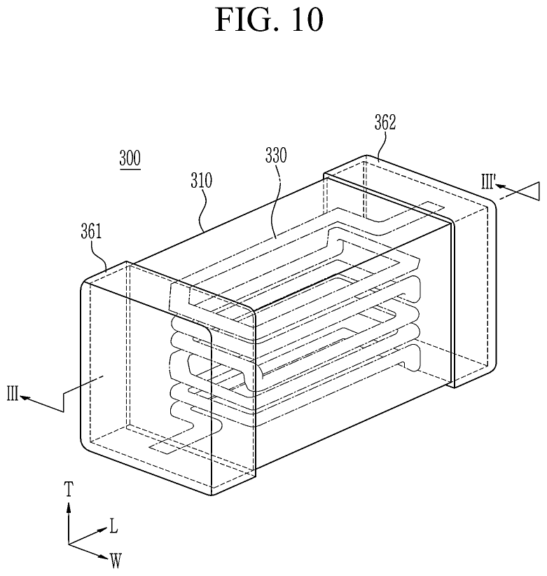

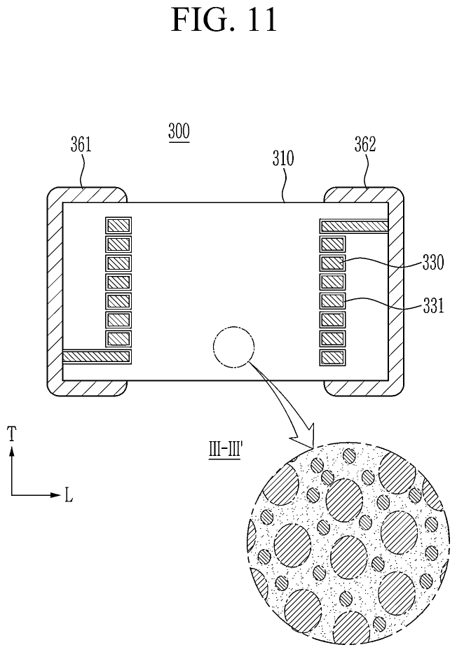

FIG. 10 schematically shows a perspective view of a multilayer-type inductor according to another embodiment and FIG. 11 schematically shows a cross-sectional view of the inductor shown in FIG. 10 in a direction III-III′ of FIG. 10.

A multilayer-type inductor 300 according to an embodiment includes a body 310 including a magnetic material including soft magnetic alloy particles, a coil 330 in the body, and external electrodes 361 and 362 on an outer surface of the body 310. The body 310 includes a plurality of magnetic sheets including the magnetic material.

The descriptions of the magnetic material and the soft magnetic alloy particles in the body 310 may be equally applied to the descriptions of the thin film-type inductor 100 according to an embodiment.

For example, the body 310 is obtained by stacking a plurality of magnetic sheets including the magnetic material in a thickness direction and firing them, wherein the shape and dimensions of the body 310 and the number of stacked magnetic sheets are not limited to those shown in an embodiment.

On one surface of the plurality of magnetic sheets, conductor patterns for forming the coil 330 is formed, and a conductive via may be formed to electrically connect the upper and lower conductive patterns in a thickness direction of the magnetic sheets.

Accordingly, one ends of the conductor patterns formed on each magnetic sheet are electrically connected to each other through the conductive via formed on the adjacent magnetic sheet, forming the coil 330.

The surface of the coil 330 may be covered with an insulating layer 331, and the insulating layer 331 may conduct a function of insulating the magnetic material of the body 310 from the coil 330. The insulating layer 331 may be applied in the same manner as the descriptions of the insulating layer 133 described above.

Both ends of the coil 330 may be drawn out through the body 310 to contact a pair of the external electrodes 361 and 362 formed in the body 310 and electrically connected thereto, respectively.

In particular, both ends of the coil 330 may be drawn out through both ends of the body 310, and the pair of external electrodes 361 and 362 may be formed at both ends of the body 310 from which the coil 330 is drawn out.

The conductor pattern may be formed by thick-film printing a conductive paste for forming a conductor pattern on a green sheet for forming the magnetic sheet and then, coating, deposition, and sputtering the conductive paste but is not limited thereto.

The conductive via may be formed by forming a through-hole in each sheet in the thickness direction and then, filling the through-hole with the conductive paste and the like but is not limited thereto.

In addition, a conductive metal included in the conductive paste for forming a conductor pattern may be one selected from silver (Ag), palladium (Pd), platinum (Pt), nickel (Ni), and copper (Cu) or an alloy thereof, but the present invention is not limited thereto.

The soft magnetic alloy particles, when included in the body of the aforementioned thin film-type, wound-type, or multilayer-type inductor, may maintain high magnetic saturation characteristics as well as improve electromagnetic properties due to its excellent characteristics.

In addition to the inductor described above, the soft magnetic alloy particles may be used for a magnetic product such as a transformer, a motor, or a stator of the motor, and the like.

Hereinafter, specific examples of the invention are presented. However, the examples described below are only intended to specifically illustrate or explain the invention, and the scope of the invention should not be limited thereto.

### EXAMPLES

### Preparation Example 1: Preparation of Soft Magnetic Alloy Particles

Fe, Co, Ge, B, P, and Cu raw materials are prepared, and the prepared raw materials are weighed so as to have the composition formula shown in Table 1. The weighed raw materials are mixed and a master alloy is prepared using an arc melting method. After melting the prepared master alloy, it is rapidly cooled in a rapid cooling facility to prepare a soft magnetic initial alloy.

The soft magnetic alloy particles of Examples 1 to 5 and Comparative Examples 1 to 11 represented by the composition formulas in Table 1 are prepared by heat-treating the initial soft magnetic alloy to the heat treatment temperature (° C.) shown in Table 1.

TABLE 1

| | | Heat | | | | | | | |
|---|---|---|---|---|---|---|---|---|---|
| | | treatment | | | | Core | Crystal | Crystal | |
| | High Ms | Temperature | Tx1 | Tx2 | Magnetic | loss | fraction | size | Ms |
| | composition | (° C.) | (° C.) | (° C.) | permeability | (Mw/cc) | (%) | (nm) | (emu/g) |
| Comparative | Fe_{82.2}Si₂B₁₁P₃Cu_{0.8} | 450 | 421 | 501 | 4858 | 1627 | 56 | 22.4 | 178 |
| Example 1 | | | | | | | | | |
| Comparative | Fe_{83.2}Si₁B₁₁P₃Cu_{0.8} | 450 | 418 | 517 | 4521 | 1824 | 57 | 22 | 179 |
| Example 2 | | | | | | | | | |
| Comparative | Fe_{81.4}Si₃B₁₁P₃Cu_{0.6} | 450 | 430 | 517 | 4585 | 1758 | 55 | 20.7 | 176 |
| Example 3 | | | | | | | | | |
| Comparative | Fe_{80.4}Si₄B₁₁P₃Cu_{0.6} | 450 | 422 | 522 | 5124 | 1757 | 56 | 20.7 | 175 |
| Example 4 | | | | | | | | | |
| Comparative | Fe_{79.4}Si₅B₁₁P₃Cu_{0.6} | 450 | 415 | 527 | 5037 | 1657 | 56 | 21.9 | 172 |
| Example 5 | | | | | | | | | |
| Comparative | Fe_{79.4}Si₅B₁₀P₄Cu_{0.6} | 450 | 410 | 530 | 4987 | 1599 | 56 | 20.4 | 172 |
| Example 6 | | | | | | | | | |
| Comparative | Fe_{78.4}Co₄Si₅B₁₀P₄Cu_{0.6} | 450 | 420 | 499 | 5014 | 1621 | 57 | 20.4 | 181 |
| Example 7 | | | | | | | | | |
| Comparative | Fe_{79.4}Co₄Si₄B₁₀P₄Cu_{0.6} | 450 | 411 | 502 | 5124 | 1677 | 55 | 20.7 | 181 |
| Example 8 | | | | | | | | | |
| Comparative | Fe_{79.4}Co₄Si₂B₁₀P₄Cu_{0.6} | 450 | 432 | 510 | 4971 | 1675 | 55 | 20.9 | 181 |
| Example 9 | | | | | | | | | |
| Comparative | Fe_{79.4}Co₄Si₂B₁₀P₄Cu_{0.6} | 450 | 420 | 518 | 4754 | 1751 | 56 | 21 | 181 |
| Example 10 | | | | | | | | | |
| Comparative | Fe_{79.4}Co₄B₁₀P_{5.5}Cu_{0.6} | 450 | 405 | 502 | 4822 | 1904 | 57 | 19.9 | 181 |
| Example 11 | | | | | | | | | |
| Example 1 | Fe_{79.4}Co₄Ge_{0.5}B₁₀P_{5.5}Cu_{0.6} | 475 | 420 | 521 | 5472 | 1587 | 59 | 17.3 | 181 |
| Example 2 | Fe_{79.4}Co₄Ge₁B₁₀P₅Cu_{0.6} | 475 | 411 | 535 | 5345 | 1574 | 60 | 17.2 | 181 |
| Example 3 | Fe_{79.4}Co₄Ge₂B₁₀P₄Cu_{0.6} | 475 | 410 | 544 | 5384 | 1544 | 59 | 17 | 181 |
| Example 4 | Fe_{78.4}Co₄Ge₃B₁₀P₄Cu_{0.6} | 475 | 410 | 551 | 5485 | 1455 | 61 | 17.1 | 180 |
| Example 5 | Fe_{77.4}Co₄Ge₄B₁₀P₄Cu_{0.6} | 475 | 414 | 549 | 5687 | 1495 | 62 | 17.3 | 179 |

### Preparation Example 2: Manufacture of Inductor

A body including a magnetic material in which the soft magnetic alloy particles prepared according to Preparation Example 1 are dispersed in a resin is manufactured, and then, an inductor including the body is manufactured.

### EXPERIMENTAL EXAMPLES

### Experimental Example 1: Ge Content Difference Analysis Between Amorphous Phase and Crystal Phase

Ge contents in amorphous phase and crystalline phases of soft magnetic alloy particles included in each of the inductors according to the examples and the comparative examples and a difference of the Ge contents are analyzed.

After putting the inductors in an epoxy mixed solution and then, curing them, the L-axis and T-axis direction surfaces of each inductor are polished to a ½ point of the W-axis direction and fixed in a vacuum atmosphere chamber, obtaining cross-section samples of the inductor bodies.

As for the obtained cross-section samples of the inductor bodies, the soft magnetic alloy particles dispersed in the resin are line-analyzed by using EDS (Energy Disperse X-Ray Spectrometer) installed in a transmission electron microscope (TEM).

Specifically, in the line analysis, a line profile obtained through a spot quantitative analysis of 20 nm to the inside and 200 nm to the outside based on the surface of any nanocrystal particle, a maximum value inside the nanocrystal particle and a maximum value in the amorphous phase portion of the nanocrystal particle are compared. The spot quantitative analysis is performed respectively at 6 points, and an average of the Ge contents is calculated.

Herein, each average Ge atomic content (Ge(a), Ge(c)) (unit: at %) in the amorphous phase and crystalline phases and a content difference (Ge(a)−Ge(c)) (unit: at %) are shown in Table 2.

Referring to Table 2, the average Ge atomic content in the amorphous phase (Ge(a)) is higher than that in the crystalline phase (Ge(c)). Accordingly, Ge elements having a relatively larger atomic weight (than those of an Si element and the like) may remain in the amorphous phase and play a role of suppressing growth of the nanocrystals in the soft magnetic alloy particles.

TABLE 2

| | Ge element added composition | | | | | | | | | | | | | | |
|---|---|---|---|---|---|---|---|---|---|---|---|---|---|---|---|
| | Ge(a) | | | | | | | Ge(c) | | | | | | | Ge(a) − |
| | 1 | 2 | 3 | 4 | 5 | 6 | avg | 1 | 2 | 3 | 4 | 5 | 6 | avg | Ge(c) |
| Fe_{79.4}Co₄Ge_{0.5}B₁₀P_{5.5}Cu_{0.6} | 0.32 | 0.35 | 0.27 | 0.31 | 0.29 | 0.25 | 0.3 | 0.19 | 0.17 | 0.13 | 0.19 | 0.21 | 0.22 | 0.19 | 0.11 |
| Fe_{79.4}Co₄Ge₁B₁₀P₅Cu_{0.6} | 0.57 | 0.61 | 0.57 | 0.6 | 0.65 | 0.63 | 0.61 | 0.44 | 0.47 | 0.46 | 0.44 | 0.39 | 0.5 | 0.45 | 0.16 |
| Fe_{79.4}Co₄Ge₂B₁₀P₄Cu_{0.6} | 1.25 | 1.18 | 1.31 | 1.28 | 1.32 | 1.27 | 1.27 | 0.79 | 0.81 | 0.69 | 0.97 | 0.85 | 0.88 | 0.83 | 0.44 |
| Fe_{78.4}Co₄Ge₃B₁₀P₄Cu_{0.6} | 1.81 | 1.65 | 1.71 | 1.74 | 1.94 | 1.82 | 1.78 | 1.2 | 1.11 | 1.16 | 1.34 | 1.34 | 1.21 | 1.23 | 0.55 |
| Fe_{77.4}Co₄Ge₄B₁₀P₄Cu_{0.6} | 2.59 | 2.44 | 2.61 | 2.51 | 2.39 | 2.41 | 2.49 | 1.96 | 1.88 | 2.01 | 1.9 | 1.81 | 1.76 | 1.89 | 0.61 |

### Experimental Example 2: DTA Analysis

The soft magnetic alloy particles of the examples and the comparative examples are prepared into a ribbon shape with a thickness of 20 um by using a rapid cooling ribbon facility to conduct a DTA analysis. Through this analysis, a first crystallization temperature Tx₁ and a second crystallization temperature Tx₂ of the particles are checked, and the results are shown in Table 1.

Referring to Table 1, in Examples 1 to 5, as the second crystallization temperature Tx₂ is increased, since a difference between the first crystallization temperature Tₓ₁ and the second crystallization temperature Tₓ₂ exceeds 100° C., a heat treatment process window for forming nanocrystals is improved.

### Experimental Example 3: Analysis of Crystal Size and Crystal Fraction

First, an XRD graph of soft magnetic alloy particles in the cross-section samples of the inductor bodies according to the examples and the comparative examples is obtained.

Each of the soft magnetic alloy particles is measured with respect to an average nanocrystal size by using a full width at half maximum (FWHM) of a main peak of the XRD graph and Scherer equation expressed by Equation 2. The results are shown in Table 1.

$$D {=}^{\frac{0.9 λ}{β cos θ}} \qquad [ Equation 2 ]$$

In Equation 2, D is an average crystal size, λ is a wavelength of an XRD target, β is a full width at half maximum (FWHM), and θ is a half of XRD graph peak 2θ.

Referring to Table 1, the nanocrystals of Examples 1 to 5 have an average crystal size of less than or equal to 20 nm (about 17 nm or so). On the contrary, the nanocrystals of Comparative Examples 1 to 11 have an average crystal size of greater than 20 nm.

In addition, after the XRD analysis, a crystal fraction is obtained by fitting the data and calculating a ratio of amorphous and crystalline areas according to [Equation 1].

Referring to Table 1, Examples 1 to 5 exhibit an improved crystal fraction of 59% or more. On the contrary, Comparative Examples 1 to 11 exhibit a crystal fraction of less than 59%.

### Experimental Example 4: Evaluation of Electromagnetic Properties

Magnetic permeability at a frequency of 1 kHz and a core loss under a magnetic field of 0.2 T and 100 kHz are measured, and the results are shown in Table 1.

Referring to Table 1, Examples 1 to 5 exhibit magnetic permeability of 5300 or more and a core loss of 1590 mW/cc or less, which confirm excellent electromagnetic properties. On the contrary, Comparative Examples 1 to 11 exhibit magnetic permeability of less than 5300 and a core loess of greater than 1590 mW/cc, which confirm deteriorated electromagnetic properties.

Furthermore, referring to Table 1, Examples 1 to 5 exhibit the above-described effects and an Ms value at a similar level at the same time, compared with Comparative Examples 1 to 11.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. Soft magnetic alloy particles, comprising:
nanocrystals and amorphous phase, and Fe (iron) and Ge (germanium),
wherein an average content of Ge in the amorphous phase is Ge(a) (at %), an average content of Ge in the nanocrystals is Ge(c) (at %), and Ge(a)−Ge(c)>0.

2. The soft magnetic alloy particles of claim 1, wherein
a composition of the soft magnetic alloy particles is represented by Composition Formula 1:
FeₐCo_{b}Ge_{c}M_{d} Composition Formula 1
wherein, in Composition Formula 1, a, b, c, and d represent an atomic percentage content (at %) of corresponding elements, respectively, 0<a≤90, 0≤b≤10, 0<c≤5, 0<d≤20, a+b+c+d=100, and
M includes B, P, Cu, Nb, Cr, C, Ni, Al, Mn, Ag, Zn, Sn, As, Sb, Bi, N, O, S, or a combination thereof.

3. The soft magnetic alloy particles of claim 2, wherein
the M does not include Si.

4. The soft magnetic alloy particles of claim 2, wherein
c satisfies 0.5≤c≤4.

5. The soft magnetic alloy particles of claim 2, wherein
a satisfies 70≤a≤80.

6. The soft magnetic alloy particles of claim 2, wherein
b satisfies 2≤b≤6.

7. The soft magnetic alloy particles of claim 2, wherein
a and b satisfy 75≤a+b≤90.

8. The soft magnetic alloy particles of claim 2, wherein
d satisfies 10≤d≤20.

9. The soft magnetic alloy particles of claim 2, wherein
Ge(a) and Ge(c) satisfy 0.1≤Ge(a)−Ge(c)≤0.7.

10. The soft magnetic alloy particles of claim 2, wherein
M includes B, P, Cu, or a combination thereof.

11. The soft magnetic alloy particles of claim 1, wherein
crystallinity of the soft magnetic alloy particles is greater than or equal to about 59% and less than or equal to about 70%.

12. The soft magnetic alloy particles of claim 1, wherein
an average crystal size of the nanocrystals is less than or equal to about 20 nm.

13. An inductor comprising:
a body including a magnetic material including soft magnetic alloy particles;
a coil in the body; and
an external electrode on an outer surface of the body,
wherein the soft magnetic alloy particles include nanocrystals and amorphous phase, and include Fe (iron) and Ge (germanium), and an average content of Ge in the amorphous phase is Ge(a) (at %) and an average content of Ge in the nanocrystal is Ge(c) (at %), and Ge(a)−Ge(c)>0.

14. The inductor of claim 13, wherein
a composition of the soft magnetic alloy particles is represented by Composition Formula 1:
FeₐCo_{b}Ge_{c}M_{d} Composition Formula 1
wherein, in Composition Formula 1, a, b, c, and d represent an atomic percentage content (at %) of corresponding elements, respectively, 0<a≤90, 0≤b≤10, 0<c≤5, 0<d≤20, a+b+c+d=100, and
M includes B, P, Cu, Nb, Cr, C, Ni, Al, Mn, Ag, Zn, Sn, As, Sb, Bi, N, O, S, or a combination thereof.

15. The inductor of claim 14, wherein
M does not include Si.

16. The inductor of claim 14, wherein
c satisfies 0.5≤c≤4.

17. The inductor of claim 13, wherein
crystallinity of the soft magnetic alloy particles is greater than or equal to about 59% and less than or equal to about 70%.

18. The inductor of claim 13, wherein
an average crystal size of the nanocrystals is less than or equal to about 20 nm.

19. The inductor of claim 13, wherein
the coil includes a support member and an upper coil and a lower coil respectively on upper and lower surfaces of the support member, and
the upper coil and the lower coil are connected through a via penetrating the support member,

20. The inductor of claim 13, wherein
the body includes a mold portion, a cover portion on one surface of the mold portion, and a core protruding from one surface of the mold portion,
wherein the coil is between one surface of the mold portion and the cover portion, and the core penetrates through the coil.

21. The inductor of claim 13, wherein
the body includes a plurality of magnetic sheets including the magnetic material.
